(19) United States
(12) Patent Application Publication
(10) Pub. No.: US 2005/0217053 A1
(43) Pub. Date: Oct. 6, 2005

(54) Robot arm mechanism

(75) Inventors: Ki-Sang Kim, Yongin-si (KR); Seung-Ki Chae, Seoul (KR)

Correspondence Address: VOLENTINE FRANCOS, & WHITT PLLC, ONE FREEDOM SQUARE, 11951 FREEDOM DRIVE SUITE 1260, RESTON, VA, 20190, US

(73) Assignee: Samsung Electronics Co., Ltd.

(21) Appl. No.: 11/015,794

(22) Filed: Dec. 20, 2004

(30) Foreign Application Priority Data
Dec. 19, 2003 (KR) 2003-93549

(51) Int. Cl. B60S 1/02

(52) U.S. Cl. 15/250.21; 414/744.5

(57) ABSTRACT

A robot arm mechanism includes a housing, upper and lower arms rotatably mounted on the housing, a respective substrate-supporting blade connected to each upper arm, and first, second, third and fourth driving units for rotating the housing, the upper and lower arms and the blade independently of one another. Thus, positions of the blades are readily controlled so that the blades and/or the substrates supported by the blades can be prevented from colliding against the inner wall of the chambers into and from which the substrates are transferred by the robot arm mechanism.

### BACKGROUND OF THE INVENTION

1. Field of the Invention

The present invention relates to a robot, and to a multi-chamber semiconductor device manufacturing apparatus in which a robot transfers substrates into and out of a processing chamber. More particularly, the present invention relates to the arm mechanism of a robot that transfers a substrate into or between processing chambers of a semiconductor device manufacturing apparatus or the like.

2. Description of the Related Art

Generally, the manufacturing of a semiconductor device includes a process of forming a layer on a substrate, a process of forming a photoresist pattern on the layer, a process of etching the layer using the photoresist pattern as an etching mask to form a circuit feature, and a process of cleaning the substrate. Apparatus for performing the above-mentioned processes typically includes several airtight chambers in which a high vacuum is maintained. More specifically, the multi-chamber apparatus includes a processing chamber, a loadlock chamber and a transfer chamber. The processing chamber and the loadlock chamber are disposed around the transfer chamber. A robot is provided in the transfer chamber for transferring a substrate to the processing chamber and loadlock chamber.

A conventional robot for transferring a substrate between chambers of a semiconductor device manufacturing apparatus is disclosed in U.S. Pat. No. 5,765,444. FIG. 1 is a perspective view of an arm mechanism of the robot. Referring to FIG. 1, the conventional robot arm mechanism includes a torso link 2 mounted on a housing 1. A first motor (not shown) for rotating the torso link 2 is disposed in the housing 1. A pair of second motors 3 is mounted on the torso link 2 at opposite sides thereof, respectively. A respective spindle 4 is connected to each of the second motors 3.

One end of a first arm 6 is mounted idly to the spindle 4. A third motor 5 rotates the first arm 6 relative to the spindle 4. A first pulley 13 is mounted on an upper end of the spindle 4 that protrudes from the first arm 6. One end of a second arm 9 is connected to a second end of the first arm 6 via a second pulley 8. The first and second pulleys 13 and 8 are connected via a first belt 7.

A blade 12 is connected to a second end of the second arm 9 via a third pulley 11. The blade 12 is configured to support a substrate. More specifically, the blade 12 may be a single type of blade that can support one substrate or a dual type of blade which can support two substrates. The second and third pulleys 8 and 11 are connected via a second belt 10. Thus, the blade 12 is rotated by the second motor 3 via the spindle 4, first pulley 13, first belt 7, second pulley 8, second belt 10 and third pulley 11.

As described above, the conventional robot arm mechanism includes the first motor for rotating the torso link 2, the second motor 3 for rotating the blade 12, and the third motor 5 for rotating the first arm 6. Accordingly, the first and second arms 6 and 9 and the blade 12 are rotated in a direction substantially identical to that in which torso link 2 is rotated by the first motor. Also, the second arm 9 and the blade 12 are rotated in a direction substantially identical to that in which the first arm 6 is rotated by the third motor 5.

Meanwhile, the rotary power generated by the second motor 3 is transmitted to the blade 12 through the spindle 4, the first pulley 13, the first belt 7, the second pulley 8, the second belt 10 and the third pulley 11. The second motor 3 rotates the second arm 9 as well as the blade 12 because the second pulley 8 is connected to the second arm 9. Thus, the blade 12 is rotated while the second arm 9 is rotated. That is, the blade 12 and the second arm 9 cannot be rotated independently of one another in the conventional robot arm mechanism. Thus, the rotation of the second arm 9 and the blade 12 must be precisely controlled to accurately position the blade 12 at the front of the processing chamber or loadlock chamber.

Accordingly, the parameters for positioning the blade 12 in the conventional robot arm mechanism basically include the relative angle of rotation of the blade 12 and the relative angle of rotation of the second arm 9. However, controlling the conventional robot arm mechanism is very difficult because these two parameters are tied to each other. Thus, the control of the robot arm mechanism is prone to error. When such a control error occurs, the blade 12 or the substrate may collide against an inner wall of the chamber, whereby the blade 12 or the substrate is damaged.

Also, the second arm 9 spreads out from the first arm 6 as the second arm 9 is rotated, and the blade 12 rotates together with the second arm 9. Thus, the working envelope of the arm mechanism, i.e., of the arms 6, 9 and blade 12, has a very long radius. Accordingly, there is great potential for a blade 12 to interfere with other arms or blades. As a result, the working range of the blade 12 may be restricted. In this case, the positions to and from which the substrate may be transferred are limited, i.e., lie within a very narrow area. Thus, the torso link 2 must be rotated using the first motor if the substrate is to be transferred to a position outside this narrow area.

Furthermore, when the conventional robot arm mechanism comprises a dual blade having first and second substrate supports, the dual blade may not be capable of being used to transfer the substrates in a desirable sequence. For example, a second substrate supported by the second support can not be sequentially loaded into the processing chamber after a first substrate supported by the first support is loaded into the processing chamber, for the following reasons. In trying to sequentially transfer the first and second substrates into the processing chamber, the dual blade should be rotated by an angle of about 180° while at a fixed position at the front of the processing chamber. However, the dual blade cannot be rotated while it remains in position because the dual blade rotates in conjunction with the articulating rotational movement of the second arm 9. Thus, it takes along time to sequentially transfer substrates into the processing chamber using a conventional robot arm mechanism comprising a dual blade.

In addition, as mentioned above, the first and second arms 6 and 9 rotate together with the blade 12. Thus, if the first, second and third pulleys 4, 8 and 11 were to have substantially identical diameters, the first and second arms 6 and 9 and the blade 12 would rotate together over substantially identical angles. In the case in which the blade is always rotated by an angle substantially identical to that of the first and second arms 6 and 9, it might not be possible to position the blade 12 in front of a desired chamber. In view of this, the first, second and third pulleys 4, 8 and 11 of the conventional robot arm mechanism have different diameters. Specifically, the second pulley 8 has a diameter smaller than that of the first pulley 4, and the third pulley 11 has a diameter smaller than that of the first pulley 4 and greater than that of the second pulley 8. Accordingly, the conventional robot arm mechanism is rather limited in terms of its design.

### SUMMARY OF THE INVENTION

An object of the present invention is to provide a robot arm mechanism capable of sequentially loading/unloading two substrates into/from one chamber in a relatively short amount of time.

Another object of the present invention is to provide a robot arm mechanism comprising a blade having one or more substrate supports each capable of supporting a respective substrate thereon, wherein the blade can be accurately placed at a desired position.

According to one aspect, the present invention provides a robot arm mechanism having a housing, a lower arm having a first and second ends, an upper arm having first and second ends, a blade having at least one substrate support, and first, second, third and fourth driving units. The first end of the lower arm is rotatably supported by the housing. The first end of the upper arm is rotatably supported by the lower arm at the second end of the lower arm. The blade rotatably supported by the arm upper arm at the second end of the upper arms. And, the first, second, third and fourth driving units that respectively rotate the housing, the lower arm, the upper arm and blade independently of one another. The first end of each of the lower and upper arms is preferably formed of a tubular member that constitutes a rotating portion of the arm.

The first driving unit includes a first motor for rotating the housing. The first motor may be directly connected to the central portion of a lower surface of the housing. Alternatively, a first motor pulley may be mounted on the first motor. A housing-rotating shaft may be mounted on the housing. A housing pulley may be mounted on a lower end of the housing-rotating shaft. The first motor pulley and the housing pulley are connected via a first belt.

The second driving unit includes a second motor, a second motor pulley mounted on a shaft of the second motor, a lower arm pulley mounted on the first end of the lower arm, and a second belt connected between the second motor pulley and the lower arm pulley.

The third driving unit includes a third motor, and an upper arm-rotating shaft disposed in the first end of the lower arm. The upper arm-rotating shaft transmits rotary power generated by the third motor to the first end of the upper arm. A third motor pulley is mounted on a shaft of the third motor pulley. An upper arm-driving pulley is mounted on a lower end of the upper arm-rotating shaft. The third motor pulley and the upper arm-driving pulley are connected via a third belt. An upper arm-driven pulley is mounted on an upper end of the upper arm-rotating shaft. A main upper arm pulley is mounted on the first end of the upper arm. The upper arm-driven pulley and the main upper arm pulley are connected via a third belt.

The fourth driving unit includes a fourth motor, a first spindle disposed in the first end of the lower arm, a second spindle extending between the second end of the lower arm and the first end of the upper arm, and a third spindle disposed in the second end of the upper arm. The upper arm-rotating shaft is rotatably received in the first spindle. The fourth motor transmits rotary power to the first spindle. The first spindle transmits the rotary power to the second spindle. The second spindle transmits the rotary power to the third spindle. The blade is mounted on the third spindle. A fourth motor pulley is mounted on a shaft of the fourth motor. A first spindle-driving pulley is mounted on a lower end of the first spindle. The second motor pulley and the first spindle-driving pulley are connected via a fifth belt. A first spindle-driven pulley is mounted on an upper end of the first spindle. A second spindle-driving pulley is mounted on a lower end of the second spindle. The first spindle-driven pulley and the second spindle-driving pulley are connected via a sixth belt. A second spindle-driven pulley is mounted on an upper end of the second spindle. A blade pulley is mounted on a lower end of the third pulley. The second spindle-driven pulley and the blade pulley are connected via a seventh belt.

### BRIEF DESCRIPTION OF THE DRAWINGS

The above and other objects, features and advantages of the present invention will become more apparent from the detailed description of the preferred embodiments that follows with reference to the attached drawings, in which:

FIG. 1 is a perspective view of a conventional robot arm mechanism;

FIG. 2 is a perspective view of a robot arm mechanism in accordance with the present invention;

FIG. 3 is a cross-sectional view of the robot arm mechanism shown in FIG. 2;

FIG. 4 is a plan view of semiconductor device manufacturing equipment comprising a robot in accordance with the present invention;

FIG. 5 is a plan view similar to that shown in FIG. 4 but showing a housing of the arm mechanism of the robot in another relative rotational position;

FIGS. 6 and 7 are plan views of the semiconductor device manufacturing equipment illustrating the transfer of a substrate into a first loadlock chamber using first and second blades of the robot arm mechanism, respectively;

FIGS. 8 and 9 are plan views semiconductor device manufacturing equipment illustrating the transfer of first and second substrates into adjacent first and second processing chambers using the first and second blades of the robot arm mechanism;

FIG. 10 is plan view of the semiconductor device manufacturing equipment illustrating the transfer of first and second substrates into a third processing chamber and a first loadlock chamber using the first and second blades of the robot arm mechanism; and

FIGS. 11 to 13 are plan views of the semiconductor device manufacturing equipment illustrating the transfer of first, second, third and fourth substrates using the first and second blades of the robot arm mechanism.

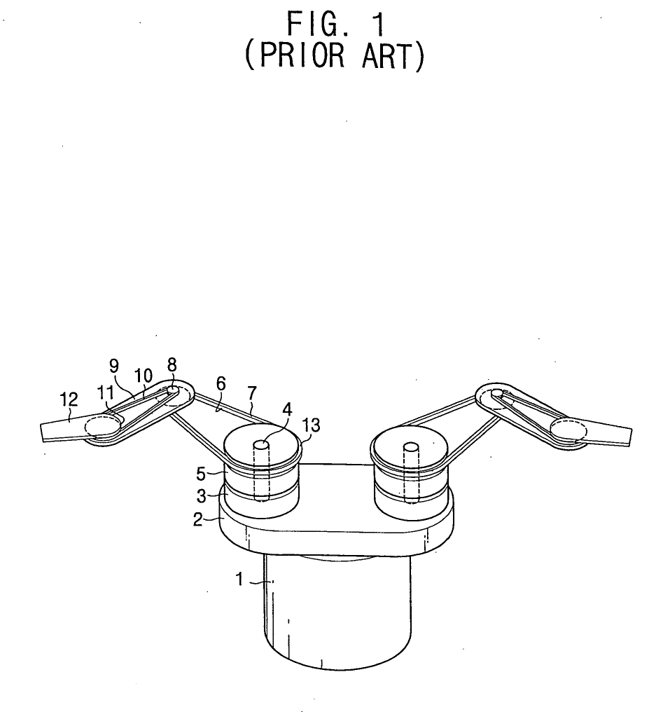

### DETAILED DESCRIPTION OF THE PREFERED EMBODIMENTS

The present invention will be described more fully hereinafter with reference to the accompanying drawings, in which preferred embodiments of the invention are shown.

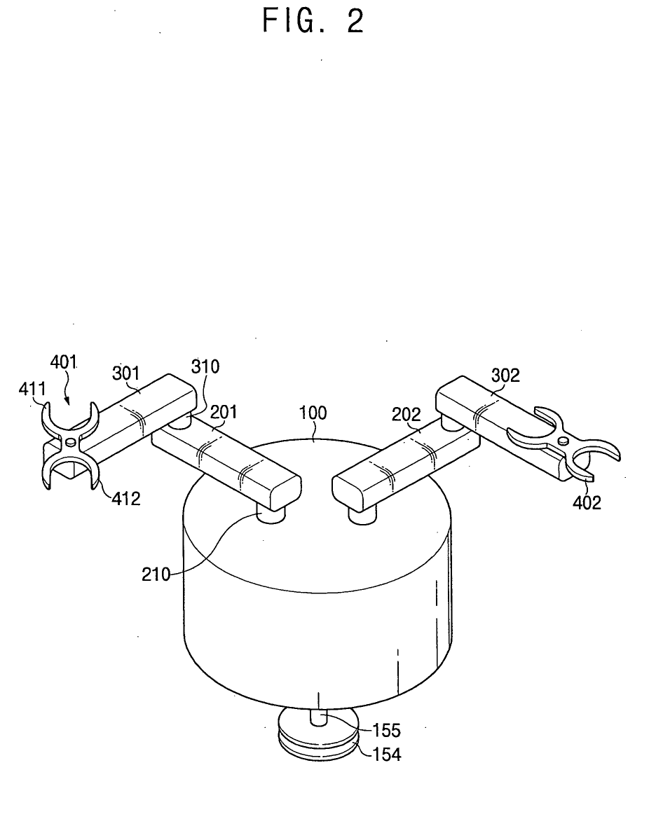

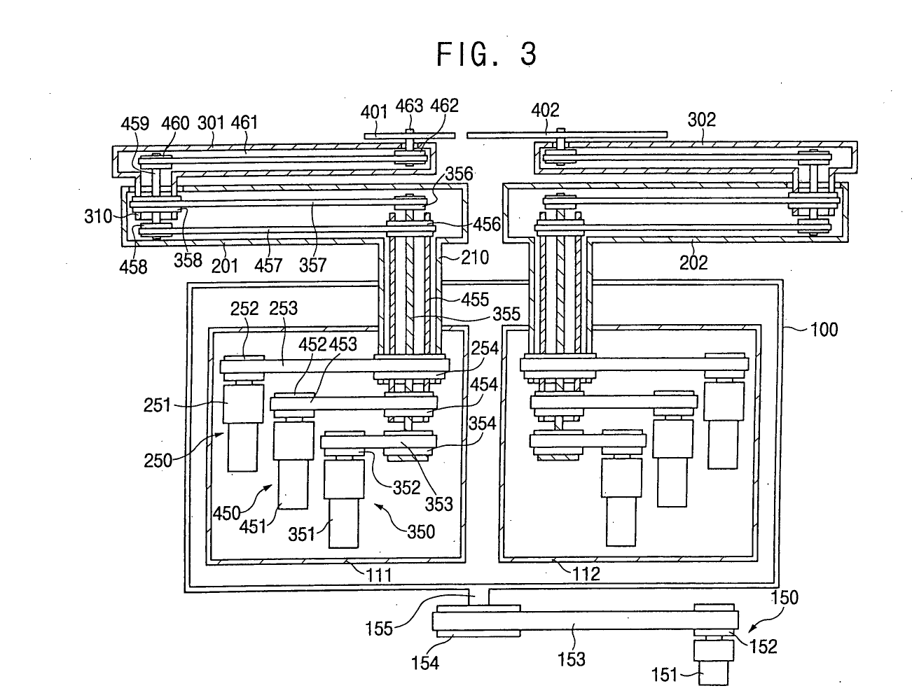

Referring to FIGS. 2 and 3, a robot arm mechanism in accordance with the present invention includes a cylindrical housing 100, first and second lower arms 201 and 202, first and second upper arms 301 and 302, first and second blades 401 and 402, and first, second, third and fourth driving units 150, 250, 350 and 450. In addition, first and second driving boxes 111 and 112 are disposed in the housing 100.

The first and second lower arms 201 and 202 are mounted to the housing 100 so as to be rotatable relative to the housing 100. The first and second upper arms 301 and 302 are disposed above the first and second lower arms 201 and 202 and are mounted so as to be rotatable relative to the first and second lower arms 201 and 202, respectively. The first and second blades 401 and 402 are disposed over the first and second upper arms 301 and 302 and are mounted so as to be rotatable relative to the first and second arms 310 and 312, respectively. The first, second, third and fourth driving units 150, 250, 350 and 450 rotate the housing 100, the first and second lower arms 201 and 202, the first and second upper arms 301 and 302, and the first and second blades 401 and 402 respectively and independently of one another.

The first driving unit 150 includes a first motor 151, a first motor pulley 152 mounted on a shaft of the first motor 151, a housing-rotating shaft 155 mounted to the central portion of the lower surface of the housing 100, a housing pulley 154 mounted on a lower end of the housing-rotating shaft 155, and a first belt 153 connecting the first motor pulley 152 and the housing pulley 154. Alternatively, the first motor 151 may be disposed under the central portion of the lower surface of the housing 100. In this case, the first motor 151 may be directly connected to the housing 100.

The first and second lower arms 201 and 202 have arm portions that are generally parallelepipedal and have substantially identical widths. The first and second lower arms 201 and 202 also have hollow tubular rotating portions 210 integral with first ends of the arm portions of the first and second lower arms 201 and 202, respectively. Lower ends of the rotating portions 210 extend within the housing 100, and within the first and second driving boxes 111 and 112, respectively. The housing 100 and the first and second driving boxes 111 and 112 rotatably support the rotating portions 210 using bearings (not shown).

The first and second upper arms 310 and 302 also have arm portions that are generally parallelepipedal and have substantially identical widths. In particular, the widths of the arm portions of the first and second upper arms 301 and 302 are substantially identical to those of the first and second lower arms 201 and 202. The first and second upper arms 310 and 302 have hollow tubular rotating portions 310 integral with first ends of the arm portions of the first and second upper arms 301 and 302, respectively. The rotating portions 310 extend into the second ends of the first and second lower arms 201 and 202, respectively.

The first and second blades 401 and 402 are rotatably supported on the second ends of the arm portions of the first and second upper arms 301 and 302, respectively. Each of the first and second blades 401 and 402 is preferably a dual type of blade having first and second substrate supports 411 and 412 by which the dual type of blade is capable of supporting and transferring two substrates at once. The first and second substrate supports 411 and 412 are symmetric with respect to the axis of rotation of the blade. Alternatively, the first and second blades 401 and 402 may each be a single type of blade having only one substrate support.

Each second driving unit 250 includes a respective second motor 251 disposed in each of the first and second driving boxes 111 and 112, a second motor pulley 252, a lower arm pulley 254, and a second belt 253. The second motor pulley 252 is mounted on a shaft of the second motor 251. The lower arm pulley 254 is mounted on the lower end of the rotating portion 210. And, the second belt 253 connects the second motor pulley 252 and the lower arm pulley 254.

Each third driving unit 350 includes a respective third motor 351 disposed in each of the first and second driving boxes 111 and 112, a respective upper arm-rotating shaft 355 extending through each of the rotating portions 210, a third motor pulley 352, an upper arm-driving pulley 352, a third belt 353, an upper arm-driven pulley 356, a main upper arm pulley 358, and a fourth belt 357. The third motor pulley 352 is mounted on a shaft of the third motor 351. The upper arm-driving pulley 352 is mounted on a lower end of the upper arm-rotating shaft 355. The third belt 353 connects the third motor pulley 352 and the upper arm-driving pulley 354. The upper arm-driven pulley 356 is mounted on the upper arm-rotating shaft 355. The main upper arm pulley 358 is mounted on the upper rotating portion 310. And, the fourth belt 357 connects the upper arm-driven pulley 356 and the main upper arm pulley 358.

Each fourth driving unit 450 includes a respective fourth motor 451 disposed in each of the first and second driving boxes 111 and 112, first, second and third spindles 455, 459 and 463, a fourth motor pulley 452, a first spindle-driving pulley 454, a fifth belt 453, a first spindle-driven pulley 456, a second spindle-driving pulley 458, a sixth belt 457, a second spindle-driven pulley 460, a blade pulley 462, and a seventh belt 461. The first spindle 455 is disposed in the lower rotating portion 210.

The first spindle 455 is tubular and receives the upper arm-rotating shaft 355 such that the upper arm-rotating shaft 355 is rotatable relative to the first spindle 455. The second spindle 459 is disposed in a rotating portion 310. The third spindle 463 is rotatably supported on the second end of the arm portion of one of the upper arms 301 and 302. In the present embodiment, the third spindle 463 and the upper arm-rotating shaft 355 extend along substantially the same axis when the upper arm 301 is fully retracted over the lower arm 201, as shown in FIG. 3. However, the present invention is not so limited. For example, the arm mechanism may be configured such that the upper arm-rotating shaft 355 is closer to the axis of rotation of the housing 100 than the third spindle 463 when the upper arm 301 is fully retracted over the lower arm 201.

The fourth motor pulley 452 is mounted on a shaft of the fourth motor 451. The first spindle-driving pulley 454 is mounted on a lower end of the first spindle 455. The fifth belt 453 connects the fourth motor pulley 452 and the first spindle-driving pulley 454. The first spindle-driven pulley 456 is mounted on an upper end of the first spindle 455. The second spindle-driving pulley 458 is mounted on a lower end of the second spindle 459. The sixth belt 457 connects the first spindle-driven pulley 456 and the second spindle-driving pulley 458. The second spindle-driven pulley 460 is mounted on an upper end of the second spindle 459. The blade pulley 462 is mounted on a lower end of the third spindle 463. The seventh belt 461 connects the second spindle-driven pulley 460 and the blade pulley 462. The first and second blades 401 and 402 are mounted on portions of the third spindles 363 that protrude upwardly from the second ends of the arm portions of the upper arms 301 and 302, respectively.

As mentioned above, the first, second, third and fourth driving units 150, 250, 350 and 450 rotate the housing 100, the first and second lower arms 201 and 202, the first and second upper arms 301 and 302, and the first and second blades 401 and 402 independently of one another. Thus, the first and second blades 401 and 402 may be positioned independently of each other. Therefore, the first and second blades 401 and 402 may be accurately moved to desired positions.

Also, the pulleys of the robot arm mechanism of the present invention may have substantially identical diameters. However, the diameters of the pulleys which are employed to transmit power in the arm mechanism are not restricted because the housing 100, the first and second lower arms 201 and 202, the first and second upper arms 301 and 302, and the first and second blades 401 and 402 may be rotated independently of one another. Accordingly, the pulleys may have different diameters.

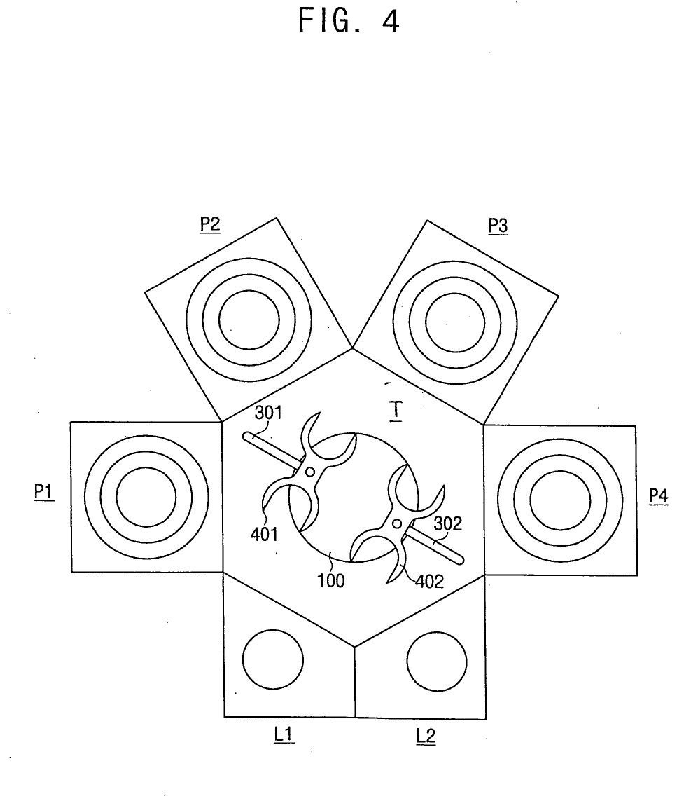

Referring to FIG. 4, the robot arm mechanism is positioned at the center of a transfer chamber T having a hexagonal sidewall. First, second, third and fourth processing chambers P1, P2, P3 and P4, and first and second loadlock chambers L1 and L2 are disposed at the six sides of the transferring chamber T, respectively. In the fully retracted position shown in the figure, the first and second upper arms 301 and 302 overlie the first and second lower arms 201 and 202, and the arm portions of the first and second blades 401 and 402 are substantially perpendicular to those of the first and second upper arms 301 and 302. Also, the housing 100 and the first lower arm 201 and the first upper arm 301 are positioned such that the arms 201 and 301 are situated between the first and second processing chambers P1 and P2 as taken in the circumferential direction of the transfer chamber T. Likewise, the second lower arm 202 and the second upper arm 302 are positioned such that the arms 202 and 302 are situated between the fourth processing chamber P4 and the second loadlock chamber L2.

From here, substrates are transferred into the first, second and third processing chamber P1, P2 and P3 and the first loadlock chamber L1 using the first blade 401. Also, substrates are transferred into the third and fourth processing chambers P3 and P4 and the first and second loadlock chambers L1 and L2 using the second blade 402. That is, substrates may be transferred into the third processing chamber P3 and the first loadlock chamber L1 using either of the first and second blades 401 and 402.

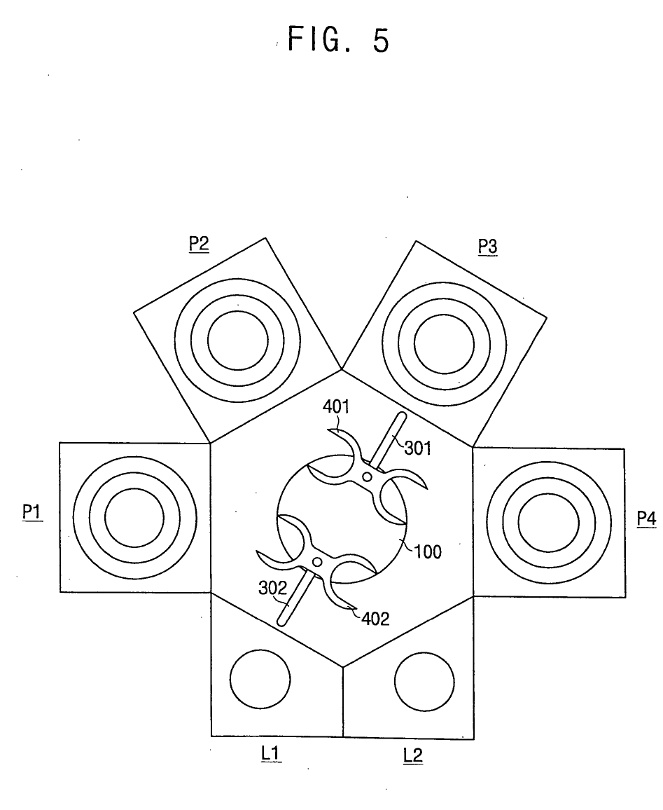

To allow for the first and second blades 401 and 402 to be capable of transferring the substrates into the chambers in a manner other than that described above, the housing 100 is rotated to a different position by the first driving unit 150. For example, with reference to FIG. 5, the first driving unit 150 rotates the housing 100 in a clockwise direction by an angle of about 90°. Thus, the arm portion of the first upper arm 301 is directed toward the third processing chamber P3, and the arm portion of the second upper arm 302 is directed toward the first loadlock chamber L1. Therefore, while the housing 100 remains at this position, substrates may be transferred into the second, third and fourth processing chambers P2, P3 and P4 using the first blade 401, and substrates may be transferred into the first processing chamber P1 and the first and second loadlock chambers L1 and L2 using the second blade 402.

Accordingly, the chambers into which substrates are transferred using the first and second blades 401 and 402 are determined in accordance with the relative angular position of the housing 100 as set by the first driving unit 150.

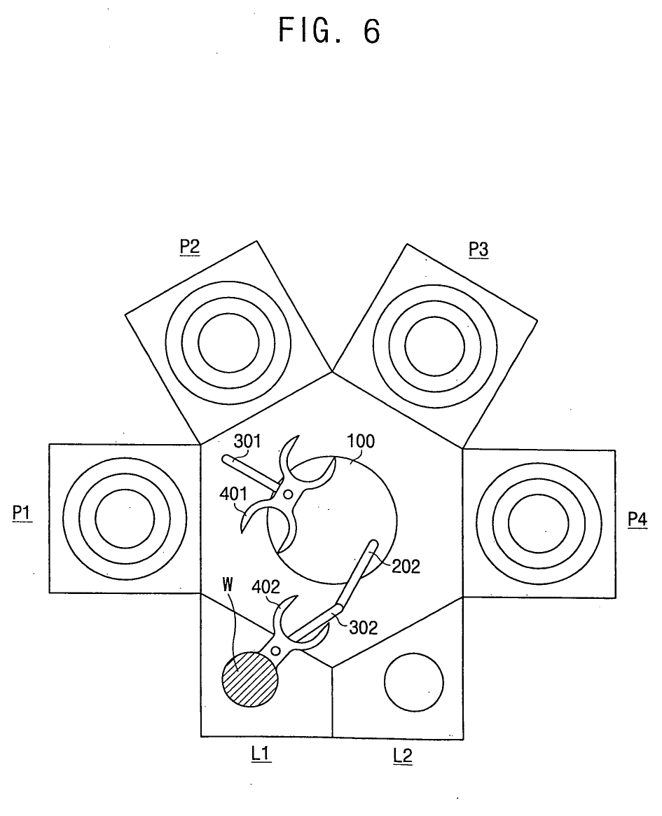

FIG. 6 illustrates an operation of transferring a substrate W into the first loadlock chamber L1 using the second blade 402. Referring to FIGS. 3 and 6, rotary power generated by the second motor 251 of the associated second driving unit 250 is transmitted to the second lower arm 202 through the second belt 253. The second lower arm 202 is thereby rotated by an angle of about 90° so as to be oriented in a position at which the arm portion of the second lower arm 202 extends toward the first loadlock chamber L1. Rotary power generated by the third motor 351 of the associated third driving unit 350 is transmitted to the second upper arm 302 through the upper arm-rotating shaft 355. The second upper arm 302 is thereby rotated by an angle of about 170° so as to be oriented in a position at which the arm portion of the second upper arm 302 extends toward the first loadlock chamber L1. Rotary power generated by the fourth motor 451 of the associated fourth driving unit 450 is transmitted to the second blade 402 through the first, second and third spindles 455, 459 and 463. The second blade 402 is thereby rotated such that the substrate support on which the substrate W is disposed enters the first loadlock chamber L1.

In this operation, the second lower arm 202, the second upper arm 302 and the second blade 402 rotate relative to one another. That is, rotational movements of the second upper arm 302 and the second blade 402 are not interlocked with the rotational movement of the second lower arm 202. Also, rotational movements of the second lower arm 202 and the second blade 402 are not interlocked with the rotational movement of the second upper arm 302. Furthermore, rotational movements of the second upper and lower arms 302 and 202 are not interlocked with the rotation of the second blade 402.

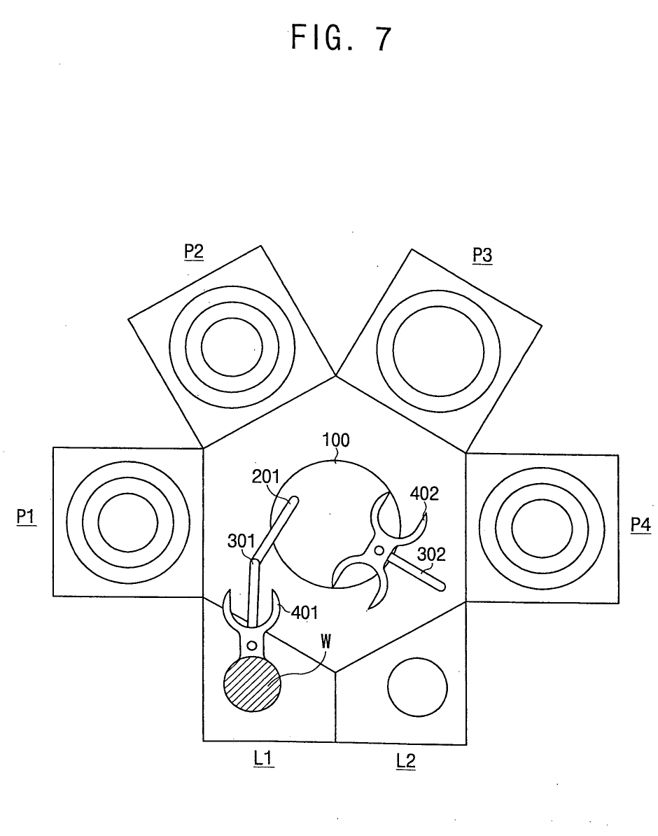

FIG. 7 illustrates an operation of transferring a substrate W from the first loadlock chamber L1 using the first blade 401. Referring to FIGS. 3 and 7, rotary power generated by the second motor 251 of the associated second driving unit 250 is transmitted to the first lower arm 201 through the second belt 253. The first lower arm 201 is thereby rotated in a counterclockwise direction by an angle of about 90° such that the arm portion of the first lower arm 201 is oriented to extend toward the first loadlock chamber L1. Rotary power generated by the associated third motor 351 of the third driving unit 350 is transmitted to the first upper arm 301 through the upper arm-rotating shaft 355. The first upper arm 301 is thereby rotated by an angle of about 170° such that the arm portion of the first upper arm 301 extends toward the first loadlock chamber L1. Rotary power generated by the fourth motor 451 of the associated fourth driving unit 450 is transmitted to the first blade 401 through the first, second and third spindles 455, 459 and 463. The first blade 401 is thereby rotated such that the first blade 401 enters the first loadlock chamber L1. The substrate W is then unloaded from the first blade 401 within the first load lock chamber L1. In this operation, the first lower arm 201, the first upper arm 301 and the first blade 401 are rotated independently of one another.

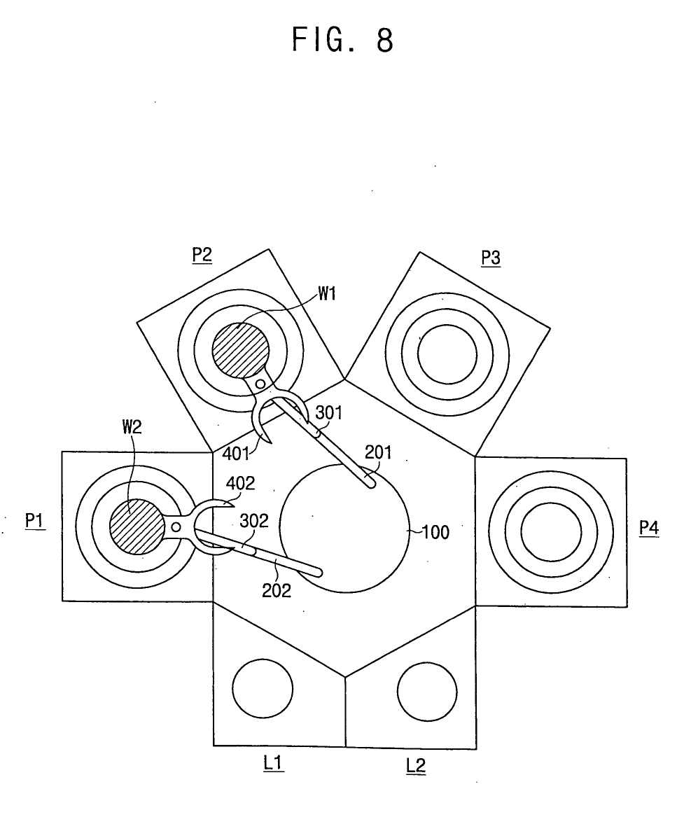

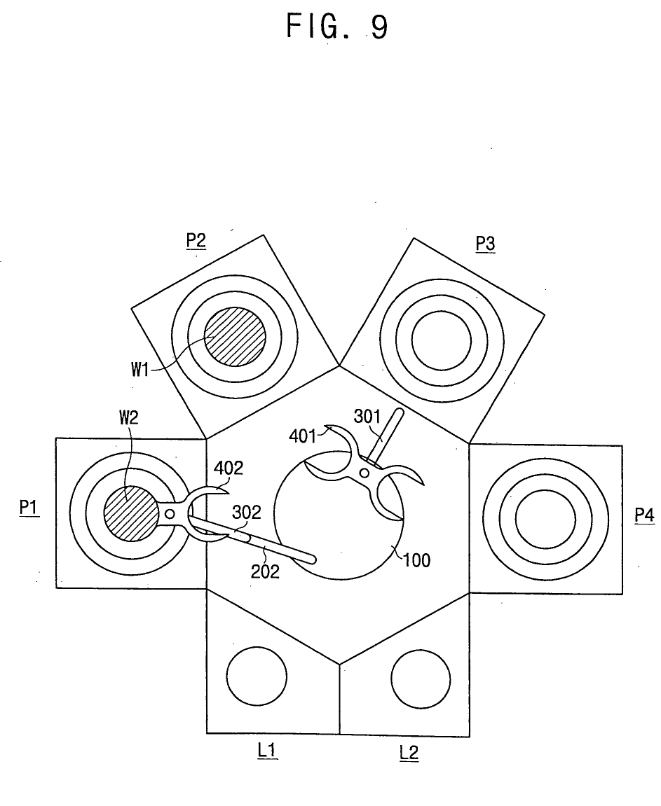

FIGS. 8 and 9 illustrate an operation of transferring first and second substrates W1 and W2 into the first and second processing chambers P1 and P2 using the first and second blades 401 and 402. Referring to FIG. 8, the first blade 401 loads the first substrate W1 into the second processing chamber P2. The second blade 402 loads the second substrate W2 into the first processing chamber P1. Referring to FIG. 9, the first blade 401 returns to its initial position while the second blade 402 is in the first processing chamber P1. Therefore, the first and second blades 401 and 402 transfer the first and second substrates W1 and W2 into the first and second processing chambers P1 and P2 without interfering with each other.

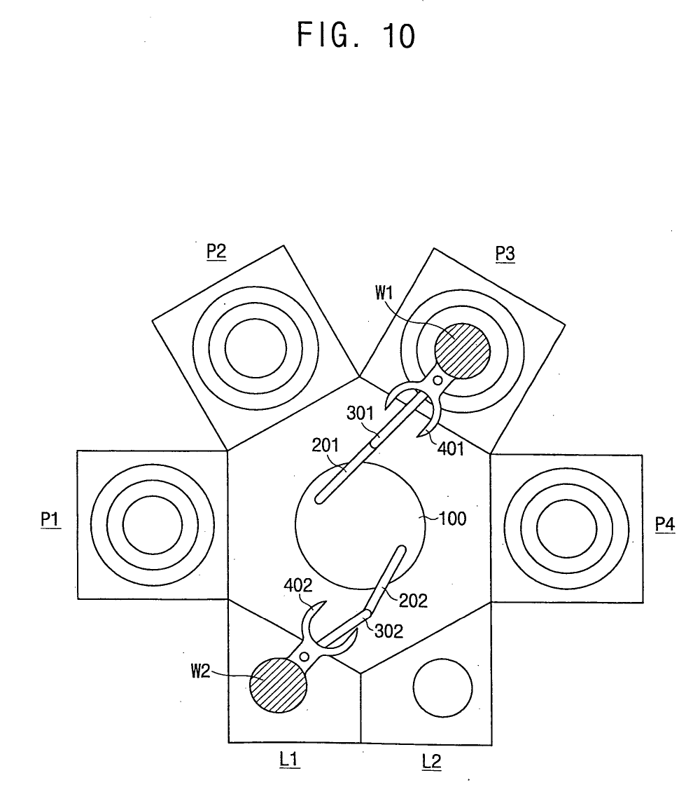

FIG. 10 illustrates an operation of transferring first and second substrates W1 and W2 into the third processing chamber P3 and the first loadlock chamber L1 using the first and second blades 410 and 402. In this operation, the first and second blades 401 and 402 transfer the first and second substrates W1 and W2 into the third processing chamber P3 and the first loadlock chamber L1, respectively. The third processing chamber P3 and the first loadlock chamber L1 are disposed opposite to each other with respect to the transfer chamber T. The first blade 401 loads the first substrate W1 into the third processing chamber P3 while the second blade 402 loads the second substrate W2 into the first loadlock chamber L1 independently of the operation of the first blade 401.

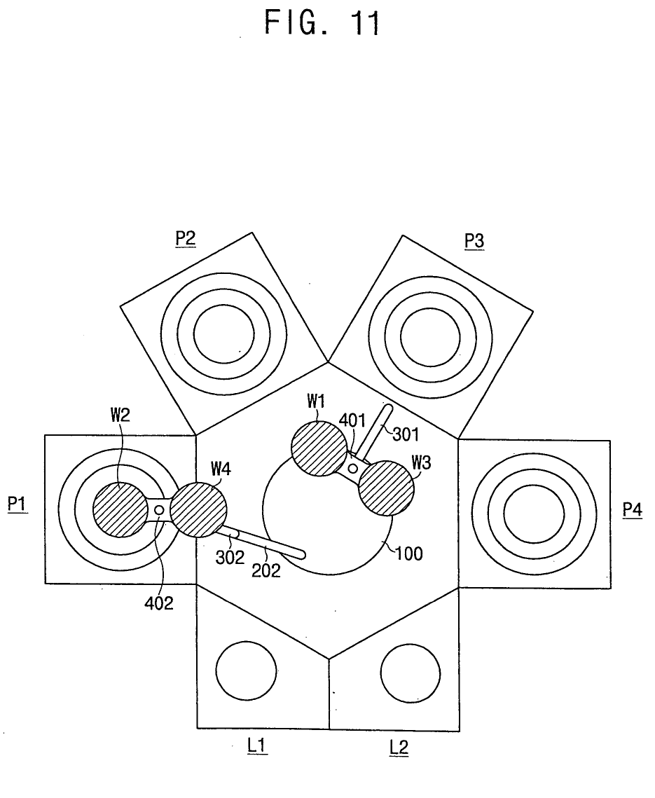

FIGS. 11 to 13 illustrate an operation of transferring first, second, third and fourth substrates W1, W2, W3, and W4 using the first and second blades 401 and 402. Referring first to FIG. 11, first and third substrates W1 and W3 are disposed on the first and second substrate supports of the first blade 401, respectively. Second and fourth substrates W2 and W4 are disposed on the first and second substrate supports of the second blade 402, respectively. The first substrate support of the first blade 401 is oriented toward the second processing chamber P2. The second substrate support of the first blade 401 is oriented toward the fourth processing chamber P4. When the first blade 401 is disposed at the initial position, the first supporting portion of the second blade 402 enters the first processing chamber P1 to load the second substrate W2 into the first processing chamber P1.

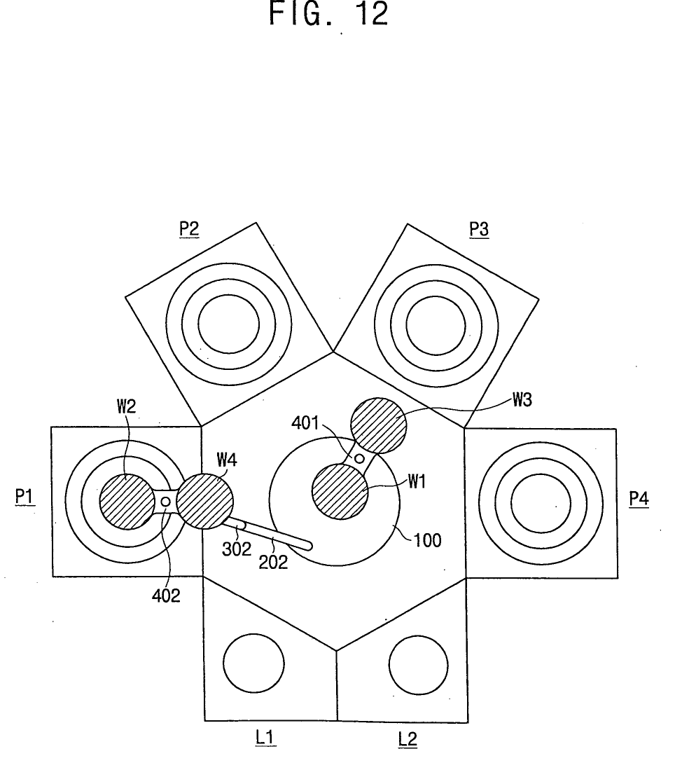

Referring to FIG. 12, the fourth driving unit 450 rotates the first blade 401 counterclockwise by an angle of about 90°. Thus, the second substrate support of the first blade 401 is oriented toward the third processing chamber P3. Accordingly, the first and third substrates W1 and W3 can be loaded into the third processing chamber P3.

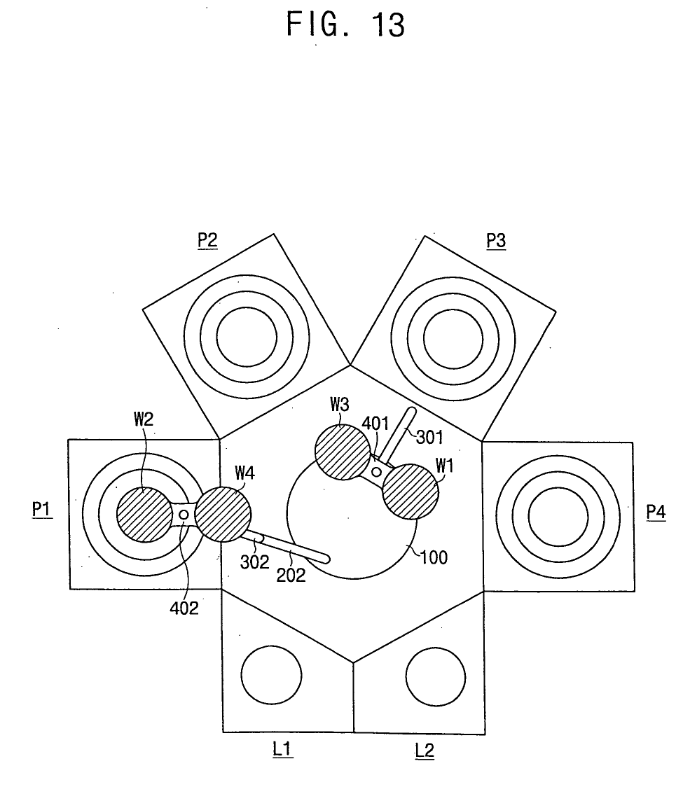

Referring to FIG. 13, the fourth driving unit 450 further rotates the first blade 401 in a counterclockwise direction by an angle of about 90°. Thus, the first supporting portion of the first blade 401 is oriented toward the fourth processing chamber P4 and the second supporting portion of the first blade 401 is oriented toward the second processing chamber P2. At this time, the first blade 401 may be rotated by an angle of about 180° without interfering with the second blade 402. In particular, the first blade 401 may be returned to its initial position, i.e., may be rotated in total by an angle of about 360°, without ever interfering with the second blade 402.

Meanwhile, the fourth driving unit 450 rotates the second blade 402 in the first processing chamber P1 by an angle of about 180°. Thus, the second substrate support of the second blade 402 enters the first processing chamber P1, and the first supporting portion of the second blade 402 exits of the first processing chamber P1 so that the fourth substrate W4 is loaded into the first processing chamber P1. The second blade 402 may be rotated without interfering with the first blade 401.

According to the present invention, the first, second, third and fourth driving units rotate the housing, the upper and lower arm and the blade respectively and independently of one another. Accordingly, the position of the blade is readily controlled so that the blade and/or the substrate(s) is/are prevented from colliding against the inner walls of the chambers. Also, if the blade is a dual type of blade, two substrates can be successively loaded/unloaded into/from one chamber while the upper arm is stationary. Furthermore, the pulleys that transmit rotational motion in the robot arm mechanism may have practically any diameter because the housing, the upper and lower arms and the blade are rotated independently of one another. Thus, the robot arm mechanism may employ pulleys all having substantially the same diameter.

Finally, although the present invention has been described above in connection with the preferred embodiments thereof, modifications and variations of the preferred embodiments will become readily apparent to persons skilled in the art. Therefore changes may be made to the preferred embodiments of the present invention within the true spirit and scope of the invention as defined by the appended claims.

1. A robot arm mechanism comprising:
a housing;
a first driving unit that rotates the housing;
a lower arm rotatably supported on the housing;
a second driving unit that rotates the lower arm relative to and independently of the rotation of the housing;
an upper arm having rotatably supported on the lower arm;
a third driving unit that rotates the upper arm relative to and independently of the rotation of each of the housing and the lower arm;
a blade rotatably supported on the upper arm, the blade having at least one substrate support configured to support a substrate; and
a fourth driving unit that rotates the blade relative to and independently of the rotation of each of the housing and the upper and lower arms.

2. The robot arm mechanism of claim 1, wherein the lower arm comprises an arm portion having first and second ends, and a rotating portion integral with and extending from the first end of the arm portion, the rotating portion of the lower arm being rotatably supported by the housing, and the upper arm comprises an arm portion having first and second ends, and a rotating portion integral with and extending from the first end of the arm portion of the upper arm, the rotating portion of the upper arm being rotatably supported at the second end of the arm portion of the lower arm, and the blade being rotatably at the second end of the arm portion of the upper arm.

3. The robot arm mechanism of claim 1, wherein the first driving unit comprises:
a first motor;
a housing-rotating shaft mounted to the housing; and
a first belt connecting the first motor and the housing-rotating shaft.

4. The robot arm mechanism of claim 3, wherein the first driving unit further comprises:
a first motor pulley mounted on an output shaft of the first motor; and
a housing pulley mounted on the housing-rotating shaft and connected to the first motor pulley via the first belt.

5. The robot arm mechanism of claim 2, wherein the second driving unit comprises:
a second motor disposed in the housing; and
a second belt connected between the second motor and the rotating portion of said lower arm.

6. The robot arm mechanism of claim 5, wherein the second driving unit further comprises:
a second motor pulley mounted on a shaft of the second motor; and
a lower arm pulley mounted on the rotating portion of the lower arm and connected to the second motor pulley via the second belt.

7. The robot arm mechanism of claim 2, wherein the third driving unit comprises:
a third motor disposed in the housing;
an upper arm-rotating shaft disposed in the rotating portion of the lower arm;
a third belt connected between the third motor and the upper arm-rotating shaft; and
a fourth belt connected between the upper arm-rotating shaft and the rotating portion of the upper arm.

8. The robot arm mechanism of claim 7, wherein the third driving unit further comprises:
a third motor pulley mounted on a shaft of the third motor;
an upper arm-driving pulley mounted on a lower end of the upper arm-rotating shaft and connected to the third motor pulley via the third belt;
an upper arm-driven pulley mounted on an upper end of the upper arm-rotating shaft; and
a main upper arm pulley mounted on the rotating portion of the upper arm and connected to the upper arm-driven pulley via the fourth belt.

9. The robot arm mechanism of claim 1, wherein the fourth driving unit comprises:
a fourth motor disposed in the housing;
a first spindle disposed in the rotating portion of the lower arm;
a fifth belt connected between the fourth motor and the first spindle;
a second spindle disposed in the rotating portion of said upper arm;
a sixth belt connected between the first and second spindles;
a third spindle having a lower end that is rotatably supported on the arm portion of the upper arm and an upper end on which the blade is mounted; and
a seventh belt connected between the second and third spindles.

10. The robot arm mechanism of claim 9, wherein the fourth driving unit further comprises:
a fourth motor pulley mounted on a shaft of the fourth motor;
a first spindle-driving pulley mounted on a lower end of the first spindle and connected to the fourth motor pulley via the fifth belt;
a first spindle-driven pulley mounted on an upper end of the first spindle;
a second spindle-driving pulley mounted on a lower end of the second spindle and connected to the first spindle-driven pulley via the sixth belt;
a second spindle-driven pulley mounted on an upper end of the second spindle; and
a blade pulley mounted on a lower end of the third spindle and connected to the second spindle-driven pulley via the seventh belt.

11. The robot arm mechanism of claim 1, wherein the blade comprises first and second substrate supports each configured to support a respective substrate, whereby the blade can support two substrates at a time.

12. The robot arm mechanism of claim 1, and further comprising:
a second lower arm rotatably supported on the housing;
a second upper arm having rotatably supported on the lower arm; and
a second blade rotatably supported on the second upper arm, the second blade having at least one substrate support configured to support a substrate.

13. The robot arm mechanism of claim 1, wherein the arm portion of the upper arm has a width substantially identical to that of the arm portion of the lower arm.

14. A robot arm mechanism comprising:
a housing;
a first driving unit that rotates the housing;
first and second lower arms each comprising an arm portion having first and second ends, and a rotating portion integral with and extending from the first end of the arm portion, the rotating portions of the lower arms being rotatably supported by the housing;
second driving units that respectively rotate the first and second lower arms relative to and independently of the rotation of the housing;
first and second upper arms rotatably supported on the second ends of the arm portions of the first and second lower arms, respectively;
third driving units that respectively rotate the first and second upper arms relative to and independently of the rotation of each of the housing and the first and second lower arms;
first and second blades rotatably supported on the second end of the arm portions of the first and second upper arms, respectively, the first and second blades each having at least one substrate support configured to support a substrate; and
fourth driving units that respectively rotate the first and second blades relative to and independently of the rotation of each of the housing, the first and second upper arms, and the first and second lower arms.

15. The robot arm mechanism of claim 14, wherein each of the first driving units comprises a first motor, a housing-rotating shaft mounted on the housing, and a first belt connected between the first motor and the housing-rotating shaft,
each of the second driving units comprises a second motor disposed in the housing, and a second belt connected between the second motor and the lower rotating portion of a respective on of the first and second lower arms,
each of the third driving units comprises a third motor disposed in the housing, an upper arm-rotating shaft disposed in the lower rotating portion of a respective one of the first and second lower arms, a third belt connected between the third motor and the upper arm-rotating shaft, and a fourth belt connected between the upper arm-rotating shaft and the rotating portion of a respective one of the first and second upper arms, and
each of the fourth driving units comprises a fourth motor disposed in the housing, a first hollow tubular spindle in which the upper arm-rotating shaft is rotatably received, a fifth belt connected between the fourth motor and the first spindle, a second spindle disposed in the rotating portion of the respective one of the first and second upper arms, a sixth belt connected between the first and second spindles, a third spindle having a lower end that is rotatably supported on the respective one of the first and second upper arms and an upper end on which a respective one of the first and second blades is mounted, and a seventh belt connected between the second and third spindles.

16. The robot arm mechanism of claim 15, wherein the first driving unit further comprises a first motor pulley mounted on a shaft of the first motor, and a housing pulley mounted on the housing-rotating shaft and connected to the first motor pulley via the first belt,
each of the second driving units further comprises a second motor pulley mounted on a shaft of the second motor, and a lower arm pulley mounted on the rotating portion of the respective one of the first and second lower arms and connected to the second motor pulley via the second belt,
each of the third driving units further comprises a third motor pulley mounted on a shaft of the third motor, an upper arm-driving pulley mounted on a lower end of the upper arm-rotating shaft and connected to the third motor pulley via the third belt, an upper arm-driven pulley mounted on an upper end of the upper arm-rotating shaft, and a main upper arm pulley mounted on the rotating portion of the respective one of the first and second upper arms and connected to the upper arm-driven pulley via the fourth belt, and
each of the fourth driving units further comprises a fourth motor pulley mounted on a shaft of the fourth motor, a first spindle-driving pulley mounted on a lower end of the first spindle and connected to the fourth motor pulley via the fifth belt, a first spindle-driven pulley mounted on an upper end of the first spindle, a second spindle-driving pulley mounted on a lower end of the second spindle and connected to the first spindle-driven pulley via the sixth belt, a second spindle-driven pulley mounted on an upper end of the second spindle, and a blade pulley mounted on a lower end of the third spindle and connected to the second spindle-driven pulley via the seventh belt.

17. The robot arm mechanism of claim 16, wherein the pulleys have substantially identical diameters.

18. The robot arm mechanism of claim 14, wherein the arm portions of the first and second upper arms the arm portions of the first and second lower arms have substantially identical widths.
